(19) United States
(12) Patent Application Publication
(10) Pub. No.: US 2023/0071307 A1
(43) Pub. Date: Mar. 9, 2023

(54) MANAGING DATABASE QUOTAS WITH A SCALABLE TECHNIQUE

(71) Applicant: salesforce.com, inc., San Francisco, CA (US)

(72) Inventors: Luis Miguel De Bello, Buenos Aires (AR); Marcos Singermann, Buenos Aires (AR); Pablo Martin Rodriguez, Buenos Aires (AR); Fernando Carlos Federico, Buenos Aires (AR)

(73) Assignee: salesforce.com, inc., San Francisco, CA (US)

(21) Appl. No.: 17/446,937

(22) Filed: Sep. 3, 2021

(51) Int. Cl. G06F 16/25; G06F 9/54; G06F 11/32

(52) U.S. Cl. CPC G06F 16/252; G06F 9/546; G06F 11/328

(57) ABSTRACT

A method and system for providing a scaling quota for a database system have been developed. The method defines a product that is defined by a client using a quota application programming interface (API). A report is created for the defined product with the quota API that is unique to the defined product and specifies a product quota and a limit endpoint for the report. The product quota is managed with a message broker by keeping an updated quota count for each report and product quota. An approval or rejection message is generated by the message broker for the client once the updated quota count reaches the limit endpoint. Finally, a response to the approval or rejection message from the client is generated for the database client by a limit provider application programming interface (API).

### TECHNICAL FIELD

One or more implementations relate to the field of database operations; and more specifically, to the management of quotas with a scalable technique.

### BACKGROUND ART

Database products usually offer several features to the same clients or even to different clients. At a certain point, the product needs to define some quotas/limits for their features. Some examples include allowing a limited number of brokers or management locks per unique scope. Other techniques include restricting the number of deployed applications per environment or based on the numbers of cores. Consequently, there is a need for managing quotas to apply later enforcements in a simple manner.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating high level view of a system for managing quotas according to some example implementations.

FIG. 2 is a flow block diagram illustrating a method for method for registering new products for quotas systems according to some example implementation.

FIG. 3 is a detailed flow diagram illustrating a method for managing quotas according to some example implementations.

FIG. 4A is a block diagram illustrating an electronic device according to some example implementations.

FIG. 4B is a block diagram of a deployment environment according to some example implementations.

### DETAILED DESCRIPTION

The following description describes implementations for a method and system for managing database quotas with scalable techniques. The method defines a system that utilizes a quota application programming interface (API) which allows management of quotas for multiple products. A report is created for a specific product/tenant with the quota API that is unique for the defined product and specifies an endpoint for the created report. The quota system uses a message broker to orchestrate a set of steps for handling quota counts and applying enforcement of system rules such as notification upon reaching the endpoints. The whole process begins by a client publishing a message to a broker. Based on the content of each respective reports, the system analyzes the message and sends a notification to call limit providers and ensures not quotas were exceeded. After analyzing all the reports, the message is approved or rejected.

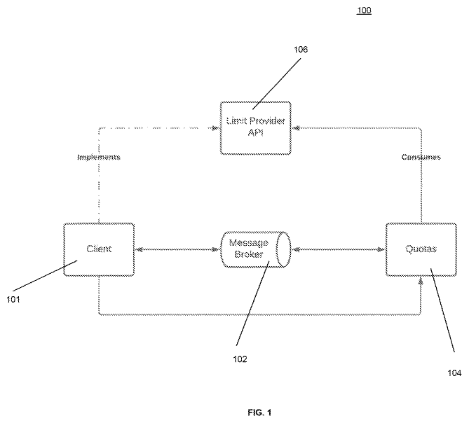

Turning now to FIG. 1, a block diagram 100 is shown illustrating a high level view for managing quotas in a system according to some example implementations. In this implementation, the client 101 communicates the quota system 104 by using a quota application programming interface (API) and a message broker 102. New products are defined by the client 101 using the quota API and enforcement of quota endpoint limits are performed by publishing messages to the broker 102. The client 101 defines and specifies a quota endpoint for the product. The message broker 102 manages the product quota 104 and keeps an updated quota count for each product. The message broker 102 generates a message for the client 101 once the updated quota count reaches the quota endpoint for the product. The client 101 responds to the message to either approve or reject an increase in the quota endpoint for the product with a limit provider application programming interface (API) 106.

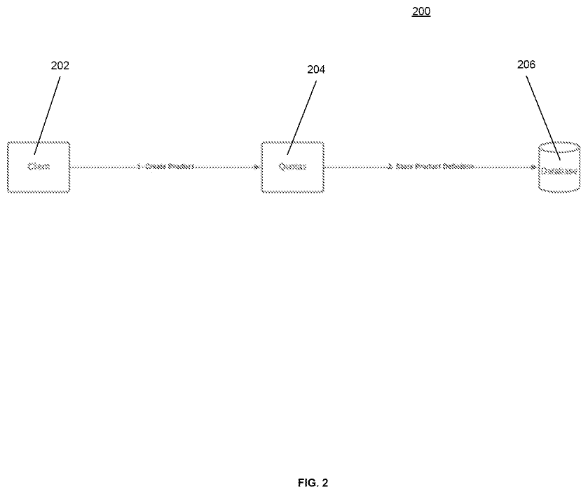

Turning now to FIG. 2, a flow block diagram 200 is shown illustrating a method for registering new products for the quota systems according to some example implementations. In this implementation, the client 202 uses the quota API 204 to define the product. After defining the product, the client 202 may define the reports and quotas. In some implementations, the limit endpoint provided for the report/quota may be a “hard limit” that could be a fixed value or dynamic value which generates a failure for the product upon reaching the quota endpoint. In alternative implementations, the quota endpoint may be a “soft limit” that could be a fixed value or dynamic value and only flag the message upon reaching an endpoint.

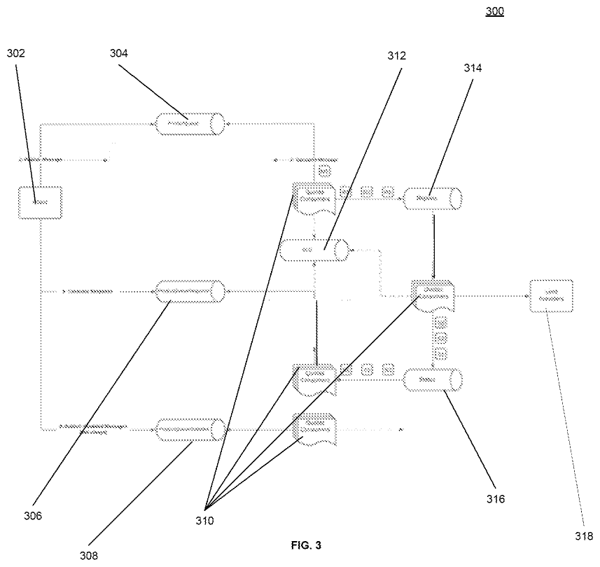

Turning now to FIG. 3, a detailed flow diagram 300 illustrating a method for managing quotas in according to some example implementations. In this implementation, a client 302 may generate requests for multiple products that run concurrently. In other implementations, the multiple concurrent product requests may be generated by multiple clients.

In the implementation shown in FIG. 3, a product queue 304 for concurrent products with each message applying multiple reports 314 that includes a quota endpoint that is generated by each client with the respective quota API 310. The “limit providers” 318 provided a maximum possible count and the quota system keeps an updated quota count to determine the status 316 for each report. When the updated quota count reaches the quota limit, one or more reports are sent to the product status queue. The responses are placed in a product response queue 306 for the as a global result based on each report. The client 302 receive the reports and send either approval or rejection. Outdated messages are placed in an outdated product status queue 308 that may be optionally published. Additionally, outdated messages are stored in a dead letter queue (DLQ) 312 for later retrieval.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

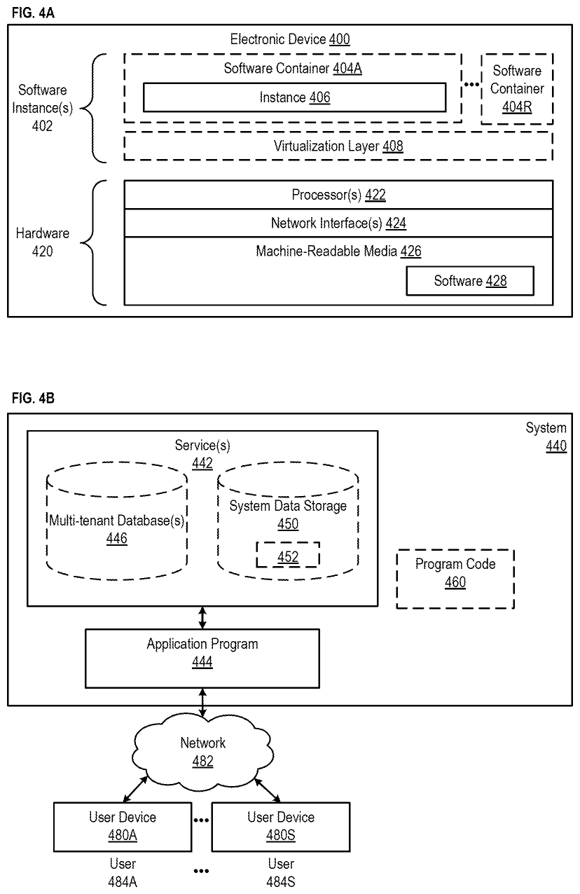

FIG. 4A is a block diagram illustrating an electronic device 400 according to some example implementations. FIG. 4A includes hardware 420 comprising a set of one or more processor(s) 422, a set of one or more network interfaces 424 (wireless and/or wired), and machine-readable media 426 having stored therein software 428 (which includes instructions executable by the set of one or more processor(s) 422). The machine-readable media 426 may include non-transitory and/or transitory machine-readable media. Each of the previously described clients and the management of scaling database quotas service may be implemented in one or more electronic devices 400. In one implementation: 1) each of the clients is implemented in a separate one of the electronic devices 400 (e.g., in end user devices where the software 428 represents the software to implement clients to interface directly and/or indirectly with the management of scaling database quotas service (e.g., software 428 represents a web browser, a native client, a portal, a command-line interface, and/or an application programming interface (API) based upon protocols such as Simple Object Access Protocol (SOAP), Representational State Transfer (REST), etc.)); 2) the management of scaling database quotas service is implemented in a separate set of one or more of the electronic devices 400 (e.g., a set of one or more server devices where the software 428 represents the software to implement the management of scaling database quotas service); and 3) in operation, the electronic devices implementing the clients and the management of scaling database quotas the management of scaling database quotas service would be communicatively coupled (e.g., by a network) and would establish between them (or through one or more other layers and/or or other services) connections for submitting requests to the management of scaling database quotas service and returning replies to the clients. Other configurations of electronic devices may be used in other implementations (e.g., an implementation in which the client and the management of scaling database quotas service are implemented on a single one of electronic device 400).

During operation, an instance of the software 428 (illustrated as instance 406 and referred to as a software instance; and in the more specific case of an application, as an application instance) is executed. In electronic devices that use compute virtualization, the set of one or more processor(s) 422 typically execute software to instantiate a virtualization layer 408 and one or more software container(s) 404A-404R (e.g., with operating system-level virtualization, the virtualization layer 408 may represent a container engine (such as Docker Engine by Docker, Inc. or rkt in Container Linux by Red Hat, Inc.) running on top of (or integrated into) an operating system, and it allows for the creation of multiple software containers 404A-404R (representing separate user space instances and also called virtualization engines, virtual private servers, or jails) that may each be used to execute a set of one or more applications; with full virtualization, the virtualization layer 408 represents a hypervisor (sometimes referred to as a virtual machine monitor (VMM)) or a hypervisor executing on top of a host operating system, and the software containers 404A-404R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 428 is executed within the software container 404A on the virtualization layer 408. In electronic devices where compute virtualization is not used, the instance 406 on top of a host operating system is executed on the “bare metal” electronic device 400. The instantiation of the instance 406, as well as the virtualization layer 408 and software containers 404A-404R if implemented, are collectively referred to as software instance(s) 402. Alternative implementations of an electronic device may have numerous variations from that described above. For example, customized hardware and/or accelerators might also be used in an electronic device.

FIG. 4B is a block diagram of a deployment environment according to some example implementations. A system 440 includes hardware (e.g., a set of one or more server devices) and software to provide service(s) 442, including the management of scaling database quotas service. In some implementations the system 440 is in one or more datacenter(s). These datacenter(s) may be: 1) first party datacenter(s), which are datacenter(s) owned and/or operated by the same entity that provides and/or operates some or all of the software that provides the service(s) 442; and/or 2) third-party datacenter(s), which are datacenter(s) owned and/or operated by one or more different entities than the entity that provides the service(s) 442 (e.g., the different entities may host some or all of the software provided and/or operated by the entity that provides the service(s) 442). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 440 is coupled to user devices 480A-480S over a network 482. The service(s) 442 may be on-demand services that are made available to one or more of the users 484A-484S working for one or more entities other than the entity which owns and/or operates the on-demand services (those users sometimes referred to as outside users) so that those entities need not be concerned with building and/or maintaining a system, but instead may make use of the service(s) 442 when needed (e.g., when needed by the users 484A-484S). The service(s) 442 may communicate with each other and/or with one or more of the user devices 480A-480S via one or more APIs (e.g., a REST API). In some implementations, the user devices 480A-480S are operated by users 484A-484S, and each may be operated as a client device and/or a server device. In some implementations, one or more of the user devices 480A-480S are separate ones of the electronic device 400 or include one or more features of the electronic device 400.

In some implementations, the system 440 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 440 is a multi-tenant cloud computing architecture supporting multiple services, such as one or more of the following types of services: Management of scaling database quotas; Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 440 may include an application platform 444 that enables PAAS for creating, managing, and executing one or more applications developed by the provider of the application platform 444, users accessing the system 440 via one or more of user devices 480A-480S, or third-party application developers accessing the system 440 via one or more of user devices 480A-480S.

In some implementations, one or more of the service(s) 442 may use one or more multi-tenant databases 446, as well as system data storage 450 for system data 452 accessible to system 440. In certain implementations, the system 440 includes a set of one or more servers that are running on server electronic devices and that are configured to handle requests for any authorized user associated with any tenant (there is no server affinity for a user and/or tenant to a specific server). The user devices 480A-480S communicate with the server(s) of system 440 to request and update tenant-level data and system-level data hosted by system 440, and in response the system 440 (e.g., one or more servers in system 440) automatically may generate one or more Structured Query Language (SQL) statements (e.g., one or more SQL queries) that are designed to access the desired information from the multi-tenant database(s) 446 and/or system data storage 450.

In some implementations, the service(s) 442 are implemented using virtual applications dynamically created at run time responsive to queries from the user devices 480A-480S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 460 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 444 includes an application setup mechanism that supports application developers' creation and management of applications, which may be saved as metadata by save routines. Invocations to such applications, including the management of scaling database quotas service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 482 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 440 and the user devices 480A-480S.

Each user device 480A-480S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 440. For example, the user interface device can be used to access data and applications hosted by system 440, and to perform searches on stored data, and otherwise allow one or more of users 484A-484S to interact with various GUI pages that may be presented to the one or more of users 484A-484S. User devices 480A-480S might communicate with system 440 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 480A-480S might include an HTTP client, commonly referred to as a “browser,” for sending and receiving HTTP messages to and from server(s) of system 440, thus allowing users 484A-484S of the user devices 480A-480S to access, process and view information, pages and applications available to it from system 440 over network 482.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A method for providing a scaling quota for a database system, comprising:
defining a product, where the product is defined by a client using a quota application programming interface (API);
creating a report for the defined product with the quota API, where the report is unique to the defined product and specifies a product quota and a limit endpoint for the report;
managing the product quota with a message broker by keeping an updated quota count for each report and product quota;
generating an approval or rejection message for the client once the updated quota count reaches the limit endpoint, where the message is generated by the message broker; and
receiving a response to the approval or rejection message from the client, where the response is generated by a limit provider API.

2. The method of claim 1, where the limit endpoint is a hard limit that is a fixed value and generates a failure for the product upon reaching the quota endpoint.

3. The method of claim 1, where the limit endpoint is a soft limit that is a fixed value and generates a flag for the product upon reaching the quota endpoint.

4. The method of claim 1, further comprising:
generating a product queue for multiple concurrent product requests for the database.

5. The method of claim 4, further comprising:
receiving the multiple concurrent report requests from different clients.

6. The method of claim 4, further comprising:
generating a report response queue for each response for each of the concurrent report requests for the client.

7. The Method of claim 4, further comprising:
generating a report status queue that indicates content of each response in the report response queue.

8. The method of claim 4, further comprising:
generating an outdated t status queue for each outdated message for the client.

9. The method of claim 8, where each message is stored in a dead letter queue (DLQ) for later retrieval.

10. An apparatus comprising:
a non-transitory machine-readable storage medium that stores software; and
a processor, coupled to the non-transitory machine-readable storage medium, to execute the software that implements providing a scaling quota for a database client and that is configurable to:
define a product that uses a database, where the product is defined by a client using a quota application programming interface (API);
create a report for the defined product with the quota API, where the report is unique to the defined product and specifies a product quota and a limit endpoint for the report;
manage the product quota with a message broker by keeping an updated quota count for each report and product quota;
generate an approval or rejection message for the client once the updated quota count reaches the limit endpoint for the report; and
receive a response to the message from the client with the a limit provider API to either approve or reject the message.

11. The apparatus of claim 10, where the limit endpoint is a hard limit that is a fixed value and generates a failure for the product upon reaching the quota endpoint.

12. The apparatus of claim 10, where the limit endpoint is a soft limit that is a fixed value and generates a flag for the product upon reaching the quota endpoint.

13. The apparatus of claim 10, where the software is configurable to:
generate a report queue for multiple concurrent report requests for the database.

14. The apparatus of claim 13, where the software is configurable to:
receive the multiple concurrent report requests from different clients.

15. The apparatus of claim 13, where the software is configurable to:
generate a report response queue for each response for each of the concurrent report requests for the database.

16. The apparatus of claim 13, where the software is configurable to:
generate a report status queue that indicates content of each response in the report response queue.

17. The apparatus of claim 13, where the software is configurable to:
generate an outdated status queue for each outdated message for the client.

18. The apparatus of claim 17, where each message is stored in a dead letter queue (DLQ) for later retrieval.
